(19) United States
(12) Patent Application Publication
(10) Pub. No.: US 2025/0321440 A1
(43) Pub. Date: Oct. 16, 2025

(54) Silicon Photonics Circuits and Methods of Manufacturing Silicon Photonic Circuits

(71) Applicant: Nippon Telegraph and Telephone Corporation, Tokyo (JP)

(72) Inventors: Yoshie Morimoto, Musashino-shi, Tokyo (JP); Kenya Suzuki, Musashino-shi, Tokyo (JP); Osamu Moriwaki, Musashino-shi, Tokyo (JP)

(21) Appl. No.: 18/873,252

(22) PCT Filed: Jun. 15, 2022
(86) PCT No.: PCT/JP2022/024032

§ 371 Date: Dec. 9, 2024

(51) Int. Cl. G02F 1/01

(52) U.S. Cl. CPC G02F 1/0147

(57) ABSTRACT

A silicon photonics circuit is configured of a support substrate, an underclad formed on one side of the support substrate, a core which is in contact with a side of the underclad opposite to the side which is in contact with the support substrate and is formed of a member containing silicon, a pattern structure which is in contact with the core, matches a shape and a size of the core in a top view, and is formed of a member having a lower refractive index than the core, and a heater which heats the core to change a refractive index of light in the core.

### TECHNICAL FIELD

The present disclosure relates to a silicon photonics circuit and a method of producing a silicon photonics circuit.

### BACKGROUND ART

In recent years, with the increase in communication traffic in data centers, the importance of optical wiring techniques for elements in computer housings has increased. In addition, particularly, silicon photonics techniques which can integrate many optical circuits at high density are attracting attention. Silicon photonics circuits function as optical transmission media in silicon photonics techniques. Silicon photonics circuits are composed of a silicon thin wire waveguide with a Si core and a SiO₂ cladding layer. The relative refractive index difference between the core and cladding layer of a silicon thin wire waveguide is approximately 40% and light propagation is possible in an extremely small cross-sectional region of several 100 nm square in the vicinity of 1550 nm which is the wavelength band used for single mode communication. Furthermore, since the silicon thin wire waveguide has a small allowable bending radius of about several μm, it is possible to form a complex wiring pattern in a narrow region.

The silicon thin wire waveguide is produced using a known silicon on insulator (SOI) substrate. The SOI substrate includes a silicon support substrate, a buried silicon oxide layer (BOX layer) on the silicon support substrate, and a silicon active layer on the BOX layer. Such silicon thin wire waveguides on SOI substrates use the BOX layer as an undercladding layer, the silicon active layer being processed into a waveguide shape as a core, and then a quartz glass film being formed as an overcladding layer on top of this core. Since silicon thin wire waveguides can be prepared on SOI substrates, monolithic integration with electronic circuits is possible. From the viewpoint of the production technique, since mature semiconductor micro-production techniques can be applied, fine patterns can be easily formed. For this reason, by combining silicon photonics techniques with semiconductor techniques and electronic circuit techniques, it is expected that optoelectronic integrated devices will be realized.

Waveguide-type devices represented by silicon photonics circuits can achieve dynamic functions by interference conditions being actively controlled, in contrast to devices which utilize optical interference phenomena such as optical branches and filters. For example, when heat is applied to the waveguide using a thin film heater or the like, a change in the refractive index of the waveguide core due to the thermo-optic effect is induced and the phase of light propagating in the waveguide can be controlled. As an application example of this phenomenon, a thermo-optical device which combines an optical branching coupler and phase control will be described below.

FIGS. 1(a) and (b) are diagrams for explaining a Mach-Zehnder interferometer (MZI) which is a known thermo-optical device, FIG. 1(a) is a top view, and FIG. 1(b) is a cross-sectional view taken along arrow lines Ib and Ib shown in FIG. 1(a). The Mach-Zehnder interferometer shown in FIGS. 1(a) and 1(b) includes directional couplers 41a and 41b which branch or combine optical signals and arm waveguides 43a and 43b. Furthermore, thin film heaters 435a and 435b are formed on the arm waveguides 43a and 43b. The directional coupler 41a is a place in which the input waveguides 48a and 48b are formed so that they can approach each other and move away from each other. The directional coupler 41b is a place in which the output waveguides 49a and 49b are formed so that they approach each other and move away from each other. As shown in FIG. 1(b), arm waveguides 43a and 43b are formed by laminating a BOX layer 402, a core layer 433, and a quartz glass film 404 on a silicon support substrate 401 and forming heat insulation grooves 45a, 45b, and 45c.

Optical signals input from input waveguides 48a and 48b are branched the using directional coupler 41a and propagated to arm waveguides 43a and 43b, respectively. The respective lights propagated to the arm waveguides 43a, 43b are output from the arm waveguides 43a, 43b and then merged again using the directional coupler 41b. At this time, if power is supplied to either of thin film heater 435a and 435b, the supplied thin film heater 435a or 435b generates heat and heats arm waveguide 43a or the arm waveguide 43b. A change in the refractive index occurs in either the heated arm waveguide 43a or the arm waveguide 43b and a difference occurs in the phase of the optical signals passing through the arm waveguides 43a and 43b. The intensity of the optical signals output from the output waveguides 49a, 49b changes depending on the phase relationship of the optical signals in the directional coupler 41b. Thermo-optical devices utilize this phenomenon to function as optical switches which can select the path of optical signals and variable optical attenuators which can adjust the amount of attenuation of optical signals.

Furthermore, in order to further reduce the power consumption of the phase shifter, there is a method of installing heat insulation grooves on both sides of the phase shifter. In the Mach-Zehnder interferometer shown in FIG. 1, heat insulation grooves 45a, 45b, and 45c are formed on both sides of the arm waveguides 43a and 43b to reduce heat flowing to both sides of arm waveguides 43a and 43b which function as phase shifters. Furthermore, forming the heat insulation grooves 45a, 45b, and 45c is effective in reducing the width of the upper and lower cladding layers and reducing the volume of the heating target. A thermo-optic phase shifter using such a waveguide type device can be applied as various functional devices.

Particularly, the thermo-optic coefficient of silicon is 2E-4[1/K], which is larger than the thermo-optic coefficient of 1E-5 of quartz glass-based materials. For this reason, a thermo-optic phase shifter formed of silicon photonics circuits can lower the heating temperature required for changing the refractive index compared with that of a thermo-optic phase shifter made of quartz glass and can reduce power consumption. Furthermore, as described above, the core of the silicon thin wire waveguide has a relative refractive index difference of about 40% with the cladding layer and can confine light in an extremely small cross-sectional region of several hundred nanometers square and the mode field diameter thereof is about 1 μm.

From the above points, in a thermo-optic phase shifter configured with a silicon thin wire waveguide, it is possible to reduce the width of the cladding layer which is the distance between heat insulation grooves to about 1 μm. Thus, the volume which needs to be heated using the thin film heater can be reduced and power consumption in the thermo-optic phase shifter can be reduced. In this way, the known technique provides a thermo-optic phase shifter with low power consumption and configured using a silicon photonics optical circuit.

### CITATION LIST

### Patent Literature

[PTL 1] Japanese Patent Application Publication No. 2009-222742

### SUMMARY OF INVENTION

However, thermo-optic phase shifters using silicon thin wire waveguides still have problems in terms of reducing power consumption. As described above, the silicon thin wire waveguide is fabricated using an SOI substrate. Due to the production method thereof, the standard thickness of the BOX layer of an SOI substrate for a silicon thin wire waveguide is about 3 μm and the upper limit is about 5 μm. For this reason, when a silicon thin wire waveguide is prepared using a standard SOI substrate, the undercladding layer of the arm waveguides 43a and 43b shown in FIG. 1 has a thickness of approximately several um. When a thermo-optic phase shifter is constructed using a silicon thin wire waveguide with a relatively thin undercladding layer, the heat applied to the arm waveguides 43a, 43b using the thin film heaters 435a, 435b is conducted downward and radiated via the silicon support substrate 401 which has good thermal conductivity. That is to say, in such a configuration, the arm waveguides 43a, 43b have poor heat insulation properties and the power consumption of the thermo-optic phase shifter increases.

FIGS. 2(a), 2(b), and 2(c) are schematic cross-sectional views for explaining a method of producing an SOI substrate having a thick BOX layer. In this method, first, as shown in FIGS. 2(a) and 2(b), a silicon support substrate 501 is oxidized for a relatively long time to form a thermal oxide film 502 with a thickness of 10 μm or more. The formed thermal oxide film 502 functions as an undercladding layer of the completed waveguide. Here, if the thermal oxide film 502 with a thickness of 10 μm or more is formed on the silicon support substrate 501, the stress applied to the front and back surfaces of the silicon support substrate 501 becomes non-uniform and warpage occurs in the entire silicon support substrate 501 at the stage shown in FIG. 2(b).

After forming the thermal oxide film 502, it is necessary to form a core layer 503 on the thermal oxide film 502, as shown in FIG. 2(c). However, as described above, since the silicon support substrate 501 is warped, it is difficult to bond single crystal silicon on the thermal oxide film 502 and grind it to about several hundred nm. Thus, a promising method for forming the core layer 503 is to bond the core layer of another SOI substrate to the silicon thermal oxide film 502. Here, when SOI substrates are bonded together, layers other than the necessary core layer are also integrated with one SOI substrate. In the example shown in FIG. 5(c), an oxide film 504 which functions as an undercladding layer of the other SOI substrate remains on the core layer 503. Although such removal of the oxide film 504 is performed by grinding and polishing, wet etching, or the like, in this case, the core layer 503 may be damaged. Also, the damage to the core layer 503 leads to in-plane non-uniformity of the core layer 503 and ultimately to deterioration of processing accuracy of the silicon waveguide core.

The present disclosure was made in view of these points and relates to a silicon photonics circuit and a method of producing a silicon photonics circuit which can suppress heat dissipation from the support substrate, save power consumed to heat the core, and form the core layer on the undercladding layer without causing warpage of the support substrate.

In order to achieve the above object, a silicon photonics circuit according to an embodiment of the present disclosure includes: a support substrate; an underclad formed on one side of the support substrate; a core which is in contact with a surface of the underclad opposite to the side which is in contact with the support substrate and is made of a member containing silicon; a pattern structure formed of a member which is in contact with the core, has a shape and a size in which it matches the core in a top view, and has a lower refractive index than the core; and a heater which heats the core to change a refractive index of light in the core.

According to the above embodiment, it is possible to provide a silicon photonics circuit and a method of producing a silicon photonics circuit which can suppress heat dissipation from the support substrate, save power consumed to heat the core, and form the core layer on the undercladding layer without causing warpage of the support substrate.

### BRIEF DESCRIPTION OF DRAWINGS

FIG. 1 is a diagram for explaining a known Mach-Zehnder interferometer in which FIG. 1(a) is a top view and FIG. 1(b) is a cross-sectional view of FIG. 1(a).

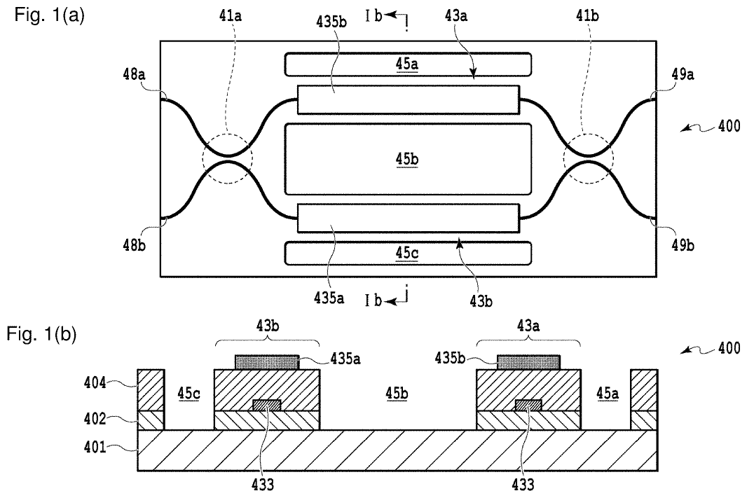

FIGS. 2(a), 2(b), and 2(c) are schematic cross-sectional views for explaining a method of producing an SOI substrate having a thick BOX layer.

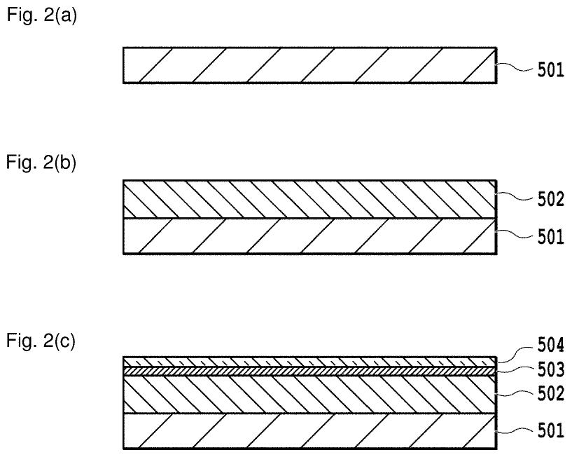

FIG. 3 is a cross-sectional view for explaining a substrate according to an embodiment of the present disclosure.

FIG. 4 is a diagram for explaining a method of producing a substrate 100 shown in FIG. 3.

FIGS. 5(a), 5(b), 5(c), and 5(d) are cross-sectional views for explaining a silicon photonics circuit according to the embodiment of the present disclosure.

FIGS. 6(a), 6(b), 6(c), and 6(d) are all cross-sectional views for explaining a step of producing a silicon photonics circuit 200 shown in FIG. 5(a).

### DESCRIPTION OF EMBODIMENTS

An embodiment of the present disclosure will be described below. The drawings referred to in this embodiment are for the purpose of explaining the configuration, an arrangement of respective parts, functions, effects, and technical concept of the silicon photonics circuit of this embodiment and are not intended to limit the specific shape thereof. Furthermore, the drawings referred to in this embodiment do not necessarily accurately represent the ratios between lengths, widths, and thicknesses.

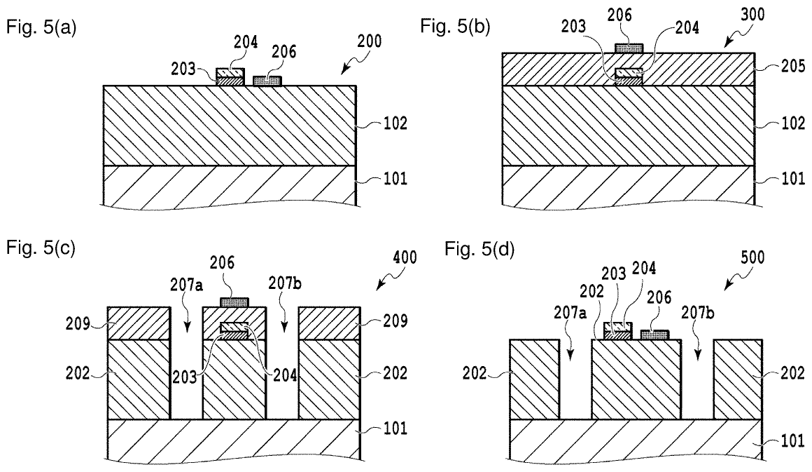

Silicon photonics circuits 200, 300, 400, and 500 (FIG. 5) of this embodiment are produced using a substrate 100. In this embodiment, first, the substrate 100 will be explained.

### Substrate

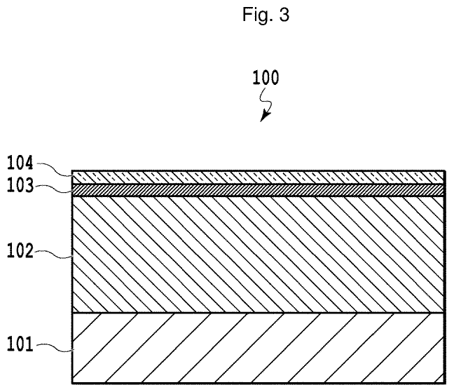

FIG. 3 is a cross-sectional view for explaining the substrate 100 of this embodiment. The substrate 100 is an SOI substrate and includes a silicon support substrate 101 that is a first support substrate, an undercladding layer 102, a core layer 103, and a glass layer 104 that is an insulation layer. In this embodiment, the following description will be provided with the direction from the silicon support substrate 101 side toward the glass layer 104 as an “upward direction”. For this reason, the undercladding layer 102 is formed on the silicon support substrate 101, the core layer 103 is formed on the undercladding layer 102, and the glass layer 104 is formed on the core layer 103. In this embodiment, the length of each layer in the direction orthogonal to the silicon support substrate 101 will also be referred to as a “thickness” hereinafter.

It is preferable that the thickness of the undercladding layer 102 be sufficiently thicker than the thickness of known undercladding. In this embodiment, the thickness of the undercladding layer 102 is 15 μm. The undercladding layer 102 is made of a material having a lower refractive index than the core layer 103. It is preferable that such a material be a material containing quartz glass containing SiO₂ as a main component and specific examples thereof include SiO₂, SiOₓ, and polymers.

The thickness of the core layer 103 may be within the range of the thickness of the core layer of a known silicon photonics circuit. This thickness may be, for example, about 0.2 μm to 1 μm. The core layer 103 is made of a material with a higher refractive index than undercladding layer 102. As such a material, for example, Si, SiN, SiON, and the like can be used.

The thickness of the glass layer 104 may be, for example, about 0.1 μm to 2 μm. For the material of the pattern structure 204 (FIG. 5(a) and the like) formed by the glass layer 104, it may satisfy the following criteria: it has a refractive index lower than that of the core layer 103 and it may be a material which is not removed in the step of removing the core layer 103 and can serve as an etching mask when etching the core layer 103 to form the core 203. As a material for such a glass layer 104, for example, SiO₂, SiOₓ, and the like can be used. The glass layer 104 made of SiO₂ or SiOₓ, that is, the pattern structure 204 (refer to FIG. 5(a) and the like) can serve as a mask in etching the Si core layer 103 using SF6. Here, the expression “can serve as an etching mask” means that the glass layer 104 is a material which is not removed from above the core layer 103 until etching of the core layer 103 is completed and does not damage the core layer 103 below the pattern structure 204 (such as in FIG. 5(a)). For such a pattern structure 204 (refer to FIG. 5(a) and the like), the thickness as well as the material are taken into consideration.

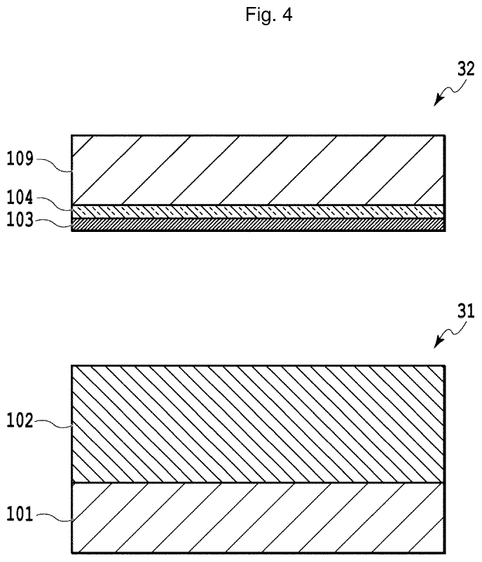

FIG. 4 is a diagram for explaining a method of producing the substrate 100 shown in FIG. 3. In this explanation, an example in which the undercladding layer 102 is made of SiO₂, the core layer 103 is made of Si, and the glass layer 104 is made of SiO₂ will be given. Producing the substrate 100 includes a step of forming an undercladding layer 102, a core layer 103, and a glass layer 104. It is preferable that the support substrate on which the undercladding layer 102 is formed be the silicon support substrate 101, but may be a glass substrate.

The step of forming the undercladding layer 102 may be any method as long as it can form the undercladding layer 102 with uniformity and smoothness which allows the core layer 103 to be formed directly thereon. Such a method includes, for example, a flame deposition method. Furthermore, the undercladding layer 102 of a thermal oxide film may be formed by thermally oxidizing the silicon support substrate 101. Here, when an oxide film with a thickness of 10 μm or more is formed on the silicon support substrate 101, stress is applied to the silicon support substrate 101 due to non-uniformity in the amount of the film formed on the front and back sides. The entire silicon support substrate 101 is warped. It is difficult to bond single crystal silicon to the undercladding layer 102 of the warped silicon support substrate 101 and grind it to a desired thickness (approximately several 100 nm). Therefore, in this embodiment, the core layer 103 is formed as follows.

The step of forming the core layer 103 on the undercladding layer 102 of this embodiment is performed by bonding the SOI substrate 32 to the substrate 31 constituted by the support substrate 101 and the undercladding layer 102. The SOI substrate 32 is a substrate which includes a silicon support substrate 109 that is a second support substrate, a core layer 103, and a glass layer 104 formed between the silicon support substrate 109 and the core layer 103 and formed of a member having a smaller refractive index than the core layer 103. The substrate 31 and the SOI substrate 32 are bonded so that the core layer 103 is in contact with the undercladding layer 102.

Furthermore, the bonding may be performed by performing room temperature bonding, confirming the bonding state, and then performing an annealing treatment at 1000° C. or higher to ensure bonding strength. Immediately after bonding, the core layer 103, glass layer 104, and silicon support substrate 109 of the SOI substrate 32 are integrated with the substrate 31. In this embodiment, the silicon support substrate 109 is removed by, for example, polishing.

After removing the silicon support substrate, the glass layer 104 may be removed by, for example, grinding and polishing, wet etching, or the like. However, removing the glass layer 104 involves the risk of damaging or peeling the core layer 103 and damage or peeling may impair the in-plane uniformity of the silicon photonics circuit. In consideration of this point, in this embodiment, at least a portion of the glass layer 104 is left without being removed at the stage of producing the substrate 100. In this embodiment, it is sufficient that a portion of the glass layer 104 remains on the core layer 103 and the glass layer 104 may be etched to a desired thickness through wet etching or the like.

According to the above method, in order to bond the flat SOI substrate 32 to the substrate 31 which has been warped due to the formation of the undercladding layer 102, the warpage of the substrate 31 is corrected using the SOI substrate 32, making it possible to form the core layer 103 on the flat undercladding layer 102.

### Silicon Photonics Circuit

FIG. 5(a), FIG. 5(b), FIG. 5(c), and FIG. 5(d) are cross-sectional views for explaining the silicon photonics circuits 200 to 500 of this embodiment. The silicon photonics circuit 200 shown in FIG. 5(a) is produced by etching the glass layer 104 and core layer 103 of the substrate 100 described above. The pattern structure 204 is formed by etching the glass layer 104 and the core 203 is formed by etching the core layer 103. The undercladding layer 102 and core 203 constitute an optical waveguide. The cross sections shown in FIGS. 5(a) to 5(d) are all cross sections taken through the optical waveguide in a direction perpendicular to the direction in which the optical signal passes. Note that the pattern structure 204 on the core 203 has a lower refractive index than the core 203 and the light passing through the optical waveguide is reflected at the interface between the core 203 and the pattern structure 204. Although such a pattern structure 204 is a residue at the time of etching the core layer 103, it also functions as an overcladding.

The silicon photonics circuit 200 shown in FIG. 5(a) includes a heater structure 206 for changing the refractive index of the core 203. The underclad 202, the core 203, and the pattern structure 204 constitute an optical waveguide and the optical waveguide including the heater structure 206 becomes a thermo-optic phase shifter. The heater structure 206 of the silicon photonics circuit 200 is formed on the same surface as the surface on which the core 203 of the undercladding layer 102 is formed. Such a configuration is advantageous in increasing the heating efficiency of the core 203 using the heater structure 206 because the heater structure 206 can be disposed close to the core 203.

More specifically, in this embodiment, the undercladding layer 102 below the core 203 has a thickness of about 15 um and a sufficient distance between the core 203 and the silicon support substrate 101 can be ensured. Also, by disposing the undercladding layer 102 having a relatively small thermo-optic coefficient and excellent heat insulation properties between them, heat insulation properties toward the bottom of the core 203 are ensured. Therefore, the heat applied to the core 203 by the heater structure 206 can be used for efficiently effecting the phase shift and the power consumption of the thermo-optic phase shifter of the silicon photonics circuit 200 can be reduced.

As described above, the etching of the core layer 103 to form the core 203 is performed using the pattern structure 204 as a mask. For this reason, the pattern structure 204 and the core 203 have the same shape and size when viewed from above. Note that the shape and the size matching between the pattern structure 204 and the core 203 when viewed from above may be determined by, for example, a visual inspection performed through a microscope and slight differences such as corners of the pattern structure 204 being rounder than the corners of the core 203 may be allowed by over-etching or the like.

FIG. 5(b) is a cross-sectional view for explaining another silicon photonics circuit 300 of this embodiment. The silicon photonics circuit 300 has a configuration in which an overcladding layer 205 is provided in addition to the silicon photonics circuit 200 shown in FIG. 5(a). The material of the overcladding layer 205 may be any material having a refractive index lower than that of the core 203. The overcladding layer 205 can be made of a member containing a silica-based glass with SiO₂ as a base material. Furthermore, the thickness of the overcladding layer 205 may be the thickness of a known overcladding layer and may be, for example, about 3 μm. It is preferable that the thickness of the undercladding layer 102 of this embodiment be twice or more that of the overcladding layer 102.

The heater structure 206 of the silicon photonics circuit 300 is formed on the opposite side of the overcladding layer 205 from the side covering the core 203 and the pattern structure 204. As in the silicon photonics circuit 200, in the silicon photonics circuit 300, the heat supplied to the core 203 using the heater structure 206 is difficult to be transmitted to the silicon support substrate 101 and heat radiation through the silicon support substrate 101 can be suppressed. Also, by providing the heater structure 206 on the overcladding layer 205 which is sufficiently thinner than the undercladding layer 102, it is possible to dispose the heater structure 206 in close proximity to, for example, directly above the core 203 to increase the heating efficiency of the core 203 by the heater structure 206.

FIG. 5(c) shows a cross-sectional view of a silicon photonics circuit 400 in which the undercladding layer 102 and the overcladding layer 205 which constitute the optical waveguide of the silicon photonics circuit 300 shown in FIG. 5(b) are patterned and removed from the silicon support substrate 101. The overclad 209, the core 203, the pattern structure 204, and an underclad 202 constitute an optical waveguide. By removing the undercladding layer 102 and the overcladding layer 205, the silicon photonics circuit 400 has a configuration including heat insulation grooves 207a and 207b formed along at least one end portion of the optical waveguide. Note that, although the heat insulation grooves 207a and 207b are provided along the two end portions of the optical waveguide in the direction in which the optical signal passes in the silicon photonics circuit 400, a heat insulation groove may be provided along one of these end portions. Furthermore, the heat insulation groove may be formed in a direction other than the direction in which the optical signal passes in accordance with the shape of the optical waveguide.

In the example of the silicon photonics circuit 400, the heater structure 206 is formed on the opposite side of the overclad 209 from the covering core 203 and the pattern structure 204. Note that the overclad 209 herein refers to the overcladding layer 205 which is patterned. For this reason, As shown in FIG. 5(b), the silicon photonics circuit 300 in which the heater structure 206 is formed on the overcladding layer 205 and the silicon photonics circuit 400 in which the heater structure 206 is formed on the overclad 209 have the same structure, except for the presence or absence of the heat insulation grooves 207a and 207b.

The silicon photonics circuit 400 having the heat insulation grooves 207a and 207b can make the volume of the overclad 209 which is heated by the heater structure 206 smaller than that of the silicon photonics circuit 300, thereby reducing the power consumed in the heater structure 206.

The silicon photonics circuit 500 shown in FIG. 5(d) has a structure in which heat insulation grooves 207a and 207b are provided in the undercladding layer 102 of the silicon photonics circuit 200 shown in FIG. 5(a) to form the underclad 202. In the silicon photonics circuit 500, the heater structure 206 is formed on the same surface as the surface on which the core 203 of the underclad 202 is formed. Note that, here, the silicon photonics circuit 200 in which the heater structure 206 is formed on the undercladding layer 102 and the silicon photonics circuit 500 in which the heater structure 206 is formed on the underclad 202 have the same structure, except for the presence or absence of the heat insulation grooves 207a and 207b. The silicon photonics circuit 500 can reduce the volume of the heating target by using the heat insulation grooves 207a and 207b and can suppress the power consumption of the heater structure 206. Furthermore, since the overclad 209 is not required, it is more advantageous than the silicon photonics circuit 400 in making the circuit thinner.

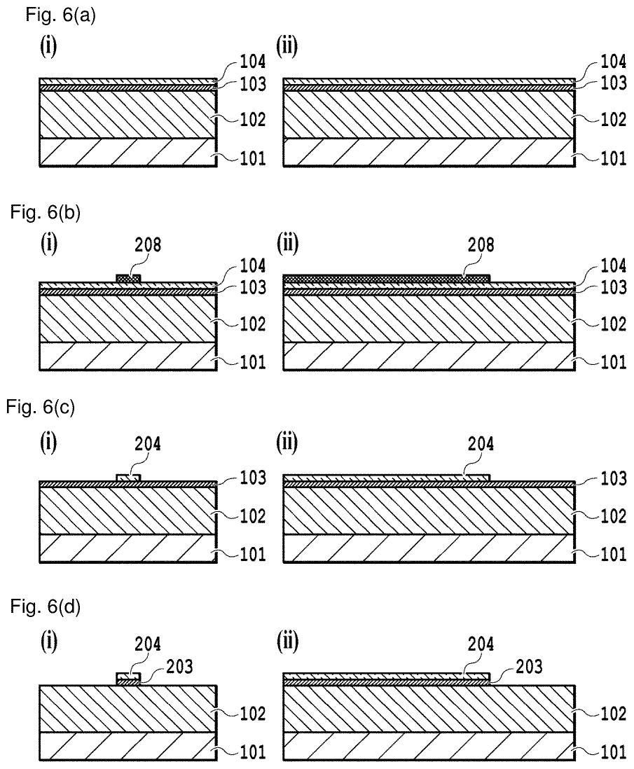

FIG. 6(a), FIG. 6(b), FIG. 6(c), and FIG. 6(d) are cross-sectional views for explaining the process of producing the silicon photonics circuit 200 shown in FIG. 5(a). In any of FIGS. 6(a) to 6(d), (i) shows a cross section perpendicular to the optical signal passing direction in the optical waveguide, as in FIGS. 5(a) to 5(d), (ii) shows a cross section parallel to the optical signal passing direction.

(i) and (ii) of FIG. 6(a) show mutually orthogonal cross sections of the substrate 100 shown in FIG. 3. In this embodiment, a mask pattern 208 is formed directly above the glass layer 104 of the substrate 100, as shown in (i) and (ii) of FIG. 6(b). A mask pattern 208 is an etching mask for the pattern structure 204. The mask pattern 208 is formed through a known photolithography technique. An electron beam drawing device, a reduction projection type exposure device, or the like may be used for resist exposure in the photolithography technique. Note that, in this embodiment, either a negative type or a positive type resist may be used, when the resist is of positive type, the portions excluding the portion which will become the mask pattern 208 are exposed, and when the resist is of negative type, the portion which will be the mask pattern 208 is exposed.

Subsequently, in this embodiment, as shown in (i) and (ii) of FIG. 6(c), the glass layer 104 is etched using the mask pattern 208 as a mask. A pattern structure 204 is formed through etching. In this embodiment, as shown in (i) and (ii) of FIG. 6(d), etching is performed using the pattern structure 204 as a mask and the core layer 103 is removed leaving a portion below the pattern structure 204 to form the core 203. Through the above steps, an optical waveguide capable of propagating light is completed. In this embodiment, a plurality of such optical waveguides are formed and the core 203 and the pattern structure 204 in each of the plurality of optical waveguides are designed to have the same line width. Furthermore, a silicon photonics optical circuit including other elements may be formed in parallel with such a process.

For example, as shown in FIG. 5(b), when providing the overclad 209, an insulation film having a refractive index lower than that of the core 203 is formed over the core 203 through, for example, flame deposition, chemical vapor deposition (CVD), or the like. Furthermore, the heater structure 206 shown in FIGS. 5(c) and 5(d) can be made of, for example, Au, Cr, Ta, TaN, TiN, or the like. The heater structure 206 can be produced by forming a heater film by, for example, RF sputtering, and processing the formed heater film by milling, reactive ion etching, or the like.

### REFERENCE SIGNS LIST

31 Substrate
32 SOI substrate
41a, 41b Directional coupler
43a, 43b Arm waveguide
45a, 45b, 45c, 207a, 207b Heat insulation groove
48a, 48b Input waveguide
49a, 49b Output waveguide
100 Substrate
101, 109, 401 Silicon support substrate
102 Undercladding layer
103, 433 Core layer
104 Glass layer
200, 300, 400, 500 Silicon photonics circuit
202 Underclad
203 Core
204 Pattern structure
205 Overcladding layer
206 Heater structure
208 Mask pattern
209 Overclad
402 Box layer
404 Quartz glass film

1. A silicon photonics circuit, comprising:
a support substrate;
an underclad formed on one side of the support substrate;
a core which is in contact with a surface of the underclad opposite to the side which is in contact with the support substrate and is made of a member containing silicon;
a pattern structure formed of a member which is in contact with the core, has a shape and a size in which it matches the core in a top view, and has a lower refractive index than the core; and
a heater which heats the core to change a refractive index of light in the core.

2. The silicon photonics circuit according to claim 1, wherein the core and the pattern structure are formed through etching, and
a material of the pattern structure is a material which is not removed during etching to form the core and is able to serve as a mask at the time of forming the core.

3. The silicon photonics circuit according to claim 1, wherein the heater is formed on the same surface of the underclad on which the core is formed.

4. The silicon photonics circuit according to claim 1, comprising:
an overclad configured to cover the core and the pattern structure,
wherein the heater is formed on a side of the overcladding opposite to a side on which it covers the core and the pattern structure.

5. The silicon photonics circuit according to claim 1, wherein the undercladding, the core, and the pattern structure constitute an optical waveguide and a heat insulation groove formed along at least one end portion of the optical waveguide is included.

6. The silicon photonics circuit according to claim 1, wherein the undercladding and the pattern structure include quartz glass containing SiO₂ as a main component.

7. The silicon photonics circuit according to claim 4, wherein a length of the underclad in a direction perpendicular to the support substrate is at least twice the length of the overclad.

8. A method of producing a silicon photonics circuit, comprising:
a step of forming an undercladding layer on a first support substrate;
a step of bonding an SOI substrate which includes a second support substrate, a core layer formed of a member containing silicon, and an insulation layer formed between the second support substrate and the core layer and formed of a member having a lower refractive index than the core layer so that the core layer is in contact with the undercladding layer;
a step of removing the second support substrate; and
a step of patterning the insulation layer and the core layer so that at least a portion of the insulation layer remains in the core layer.
